(19) United States
(12) Patent Application Publication
(10) Pub. No.: US 2021/0237400 A1
(43) Pub. Date: Aug. 5, 2021

(54) PANEL WITH STONE VENEER

(71) Applicant: Xylo Technologies AG, Niedertcufen (CH)

(72) Inventor: Dieter Döhring, Großenhain (DE)

(21) Appl. No.: 16/973,113

(22) PCT Filed: Jun. 8, 2018
(86) PCT No.: PCT/EP2018/065202

§ 371 Date: Dec. 8, 2020

(51) Int. Cl. B32B 9/00; B32B 3/06; B32B 7/12; B32B 9/04; B32B 19/04; B32B 37/12; E04F 13/08; E04F 13/14; E04F 15/10; B44C 5/04

(52) U.S. Cl. CPC B32B 9/002; B32B 2471/00; B32B 7/12; B32B 9/047; B32B 19/04; B32B 37/12; E04F 13/0875; E04F 13/144; E04F 15/107; B44C 5/0438; B32B 2262/108; B32B 2307/72; B32B 2255/02; B32B 2255/20; B32B 2607/00; B32B 3/06

(57) ABSTRACT

The present invention relates to a panel (20) and a method for manufacturing such a panel, in particular a wall, ceiling or flooring panel, comprising a carrier board (10) with a front surface and a rear surface. The carrier board (10) is a mineral wool board or a fiber cement board with a thickness of 3 to 30 mm and comprises on its front surface a layer (26) made of a stone veneer.

### 1. FIELD OF THE INVENTION

The present invention relates to a panel as well as to a method for producing such a panel, in particular a wall, ceiling or flooring panel, which is provided with a stone veneer.

### 2. TECHNICAL BACKGROUND

From the prior art, a number of panels for wall, ceiling or floorings is known. For example, as flooring components for interior use, so-called laminate panels are well-known. Laminate panels are relatively inexpensive and are easy to process. Typically, they are based on a carrier board of MDF or HDF, whereby a decor paper impregnated with a melamine resin is applied onto its front surface. By pressing under application of heat and pressure, the resin is cured such that a highly abrasion-resistant surface is created. To increase the resistance, the front surface is often provided with abrasion-resistant particles, in particular corundum, before the panel is pressed. One disadvantage of such laminate panels is that they are hardly suitable for applications outside of buildings, where they are maybe subjected to moisture and the environment.

Further, from the prior art, high quality panels based on PVC are known, which are marketed under the expression LVT (Luxury Vinyl Tiles). For example, from DE 10 2006 058 655 A1, a flooring panel in the form of a multiple layered, rectangular laminate with a carrier plate made of a soft polyvinylchloride (PVC) is known. Onto the soft PVC layer, respectively plate, a decor paper is glued, to provide the visible surface of the PVC with a decor.

Common to all these solutions is that the decor layer is an artificial decor, which is for example printed onto a paper or plastic web. The motives are particular copies of natural surfaces, as in particular of wooden surfaces. Corresponding decor papers respectively decor foils are available with a large number of different imitations of natural surfaces, as wood, stone, tiles etc.

Although modern printing techniques are capable to produce very good printing qualities, it is nevertheless in many cases desirable not to use imitations of natural materials, but to use the natural material itself.

The use and processing of natural materials, as for example wood, stone or tiles and similar, is, however, relatively complex and the materials are relatively expensive, which was one of the main reasons for the development of laminate panels in the first place. Further, for example natural stone includes additional disadvantages when handling the material, since stone is not very flexible and the material itself is very heavy. For example, in areas where natural stone is needed for large area applications or where it is desirable to keep weight to a minimum, as for example when cladding facades of buildings, veneer materials of natural stone has been proven as suitable. Veneers of natural stone consist of very thin layers, for example between 0.5 and 2 mm, of stones that are glued onto a flexible carrier material. In this way, the veneer is easy to handle and can for example be used in the form of panels as wall coverings, in particular inside of buildings. One disadvantage of the known stone veneer is, however, that the resistivity and particularly the mechanical resistivity is relatively low. These materials are therefore hardly suitable as material for floorings, for example.

In light of the known panels respectively coverings, the present invention is faced with the object to provide a panel, in particular a wall, ceiling or flooring panel, which comprises preferably the advantages of the known panels, while eliminating the mentioned disadvantages of the prior art. It is in particular an object to provide an improved panel having a stone veneer, which offers a good resistivity and which is relatively easy to install.

These and other tasks, which will be mentioned in the following description or which will be recognized by the skilled person, are solved with a panel according to claim 1 and a corresponding method for producing such a panel according to claim 15.

### 3. DETAILED DESCRIPTION OF THE INVENTION

The objects are in particular solved by a panel, as for example a wall, ceiling or flooring panel, which comprises a carrier board with a front surface and a rear surface, whereby the carrier board is a board of mineral wool or a board of fiber cement, with a thickness of preferably 3 to 30 mm, and whereby the carrier board comprises on its front surface a first layer of an adhesive, as well as a second layer of a stone veneer, which has a thickness of 0.1 to 4 mm, and which is glued onto the carrier board by means of said adhesive.

Mineral wool is a general term for fiber materials that are formed by for example spinning or drawing molten minerals. Mineral wool is also known as mineral fiber, mineral cotton, man-made mineral fiber, glass wool etc. It is commonly used as insulator for insulating buildings or as sound absorber or for fire protection purposes. To be used as a carrier board, the mineral wool has to have a sufficient stability. To this end, the wool is densified such that it has for example a density of 20 to 200 kg/m³. Boards of fiber cement are composite building and construction materials. They consist essentially of a composite of cement and a fiber reinforcement, as for example fibers of glass or cellulose. Fiber cement is well suited as material for the carrier board of the panel, due to its low cost, low weight and since it is easy to process. A thickness of for example 3 to 30 mm provides a sufficient mechanical stability, so that the panel is easy to handle and can for example readily be installed. The layer of a stone veneer is glued by means of the adhesive onto the front surface of the carrier board. The adhesive serves first for the fixation of the veneer onto the carrier board and, on the other hand, it provides preferably a certain elasticity, whereby the stone veneer is better protected against compressive loads, which for example occur when the panel is used as a flooring panel. The layer of adhesive cushions mechanical impacts and transfers those into the carrier board. For this reason, it is preferred that the layer of adhesive is provided continuously over the carrier board. However, the layer of adhesive can also be provided by means of several adhesive strings or adhesive spots, such that after the application of the stone veneer, gaps remain between the adhesive. Thus, the front surface of the carrier board does not necessarily be continuously covered with the adhesive, but it is also possible that only portions of the surface are covered, as long as the adhesive strength is sufficient.

Preferably, additional layers may be provided between the layer of adhesive and the layer made of stone veneer. In particular, the use of a primer may improve the adhesion of stone veneer, adhesive and surface of the carrier board. Additional functional layers, in particular elastic layers, are also feasible.

Preferably, the adhesive is a highly elastic polyurethane adhesive.

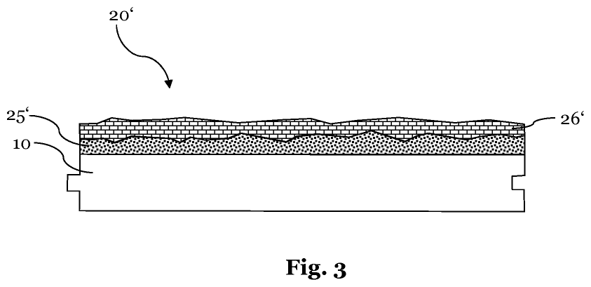

Further preferred, the layer of adhesive is applied in a thickness of 50 μm to 3 mm, even more preferred of 200 μm to 2.5 mm, yet still further preferred of 300 μm to 2 mm, and most preferred of 500 μm to 2 mm. The thickness of the adhesive should be chosen sufficiently so that preferably, the whole surface of the stone veneer is bounded via the adhesive layer with the carrier board. Since natural stone veneer does typically not have a smooth surface, but rather comprises, depending on the stone, elevations and depressions, it is preferred that the adhesive is applied such that it can level out/even out these irregularities. A full and continuous adhesion of the stone veneer is in particular advantageous, when the thus prepared board is cut into panel shape later on and when the panels are subsequently provided with a locking profile. To this end, in the area where the locking profile is provided, preferably a continuous bonding between stone veneer and carrier board should exist. For a better understanding, this is schematically shown in FIG. 3. In the final product, the adhesive layer will thus have an irregular or inhomogenous thickness, which is adapted to the elevations and depressions of the veneer layer.

It is generally preferred that the layer of adhesive also has in the final product (after curing, although the shrinkage due to curing is typically neglectable) a thickness of 50 μm to 3 mm, more preferred of 200 μm to 2.5 mm, even more preferred of 300 μm to 2 mm and most preferred of 500 μm to 2 mm. The skilled person will thus chose the thickness of the applied layer such that in the final product, the desired thickness can be achieved. A relatively thick adhesive layer further provides a certain elastic damping between the carrier board and the layer of a stone veneer applied thereon. In particular when used as a flooring panel, the mentioned thicknesses for the adhesive layer are advantageous, since the adhesive layer acts as footfall sound insulation layer and it can dampen mechanical impacts due to its elastic nature, which act onto the layer of stone veneer to prevent a cracking of the veneer.

Preferably, the adhesive is provided in an amount of 50 to 5,000 g/m², more preferred in an amount of 70 to 4,000 g/m², even more preferred of 300 to 3,000 g/m² and most preferred of 500 to 2,500 g/m². With these amounts, a secure adhesion of the stone veneer can be achieved and the resulting adhesive layer has a sufficient thickness respectively strength to achieve the above-mentioned advantages. The preferred density of the adhesive is between 1,000 and 1,700 kg/m³, more preferably between 1,200 and 1,500 kg/m³.

Preferably, the layer of adhesive has a shore A hardness (DIN EN ISO 868) of 25 to 95, more preferred of 27 to 80 and most preferred of 30 to 70. The elongation at break (according to EN (ISO 527-1), also denoted as strain at failure, is preferably between 100 and 600%, more preferred at 150 to 500% and most preferred at 200 to 400%. Such an elongation at break is advantageous, since the layer of adhesive is sufficiently elastic to provide for a good footstep sound insulation when used as a flooring panel, and to dampen any mechanical impacts against the layer of stone veneer. Thereby, the resistivity of the stone veneer, respectively the thus formed panel, is increased.

The carrier board has preferably a thickness of 3 to 20 mm, more preferred of 4 to 15 mm, even more preferred of 3 to 12 mm and most preferred of 4 to 10 mm. These thicknesses are sufficient, so that for example coupling means in the form of tongue and groove elements can be machined into the sides of the carrier boards, and so that the carrier boards have a sufficient stability such that the panels can for example be used as flooring panels. At the same time, the carrier board is still thin enough, so that only relatively little material is needed and so that the final panels are not too heavy, so that they can easily be handled and installed.

Generally preferred, the carrier board of mineral wool has a density of 20 to 180 kg/m³, more preferred of 30 to 160 kg/m³, even more preferred of 40 to 150 kg/m³ and most preferred of 60 to 130 kg/m³. Such a density provides the carrier board with sufficient mechanical stability.

Preferably, the carrier board of mineral wool comprises a modified surface, which can be achieved by treating the carrier board with an aqueous solution of water and water glass, in particular sodium silicate. The term “water glass” (also sometimes referred to as “soluble glass” as used herein describes sodium silicate, potassium silicate and lithium silicate. The treatment with water glass, in particular sodium silicate, leads surprisingly to an improved moisture resistance of the carrier board. The treatment of the carrier board is done preferably by means of an aqueous solution of water glass. For example, the carrier board may be sprayed with an aqueous solution of sodium silicate or it can be dipped into such a solution. After the treatment of the carrier board, the same is preferably dried and subsequently, the layer of stone veneer is applied. Preferably, the aqueous solution is mixed of (weight portions): 1 part water glass and 1 to 10 parts water, preferably 1 part water glass (e.g. sodium silicate) and 1.5 to 7 parts of water and most preferably 1 part water glass and 1.5 to 3 parts of water. The water glass (like e.g. sodium silicate) is preferably prepared at high pressure, for example at 4 to 5 bars and correspondingly elevated temperature of for example 130 to 150° C., since in these ranges, the solid water glass can easily dissolve in water. The aqueous solution can be treated in addition with alkaline solution and with additional water to achieve the desired composition.

Preferably, the carrier board is sprayed with the aqueous solution or it is dipped into the aqueous solution. The aqueous solution has at that moment preferably still an elevated temperature of preferably above 60° C., since the viscosity of the aqueous solution is, among others, a function of the temperature. Generally preferred, the treatment of the carrier board with the aqueous solution is therefore done at a temperature of the solution of 50 to 80° C., preferably 60 to 70° C., even more preferred 60 to 68° C.

In a method for manufacturing a panel, in particular a wall, ceiling or flooring panel, preferably the following steps occur:
a. providing a carrier board of mineral wool, with a front surface and a rear surface;
b. treating the carrier board with water glass (in particular sodium silicate);
c. glueing a layer of a stone veneer onto the front surface, which has a thickness of 0.1 to 4 mm, by means of a layer of an adhesive.

The treatment of the carrier board with water glass comprises preferably the treatment of the plate by means of an aqueous solution of water glass. Generally preferred, the aqueous solution is mixed from the above-mentioned weight portions of water glass and water. After the treatment with the aqueous solution, the carrier board is preferably dried before the layer of adhesive and thereon the stone veneer is applied.

### 4. DESCRIPTION OF PREFERRED EMBODIMENTS

In the following, the present invention is described under reference to the enclosed figures. Hereby:

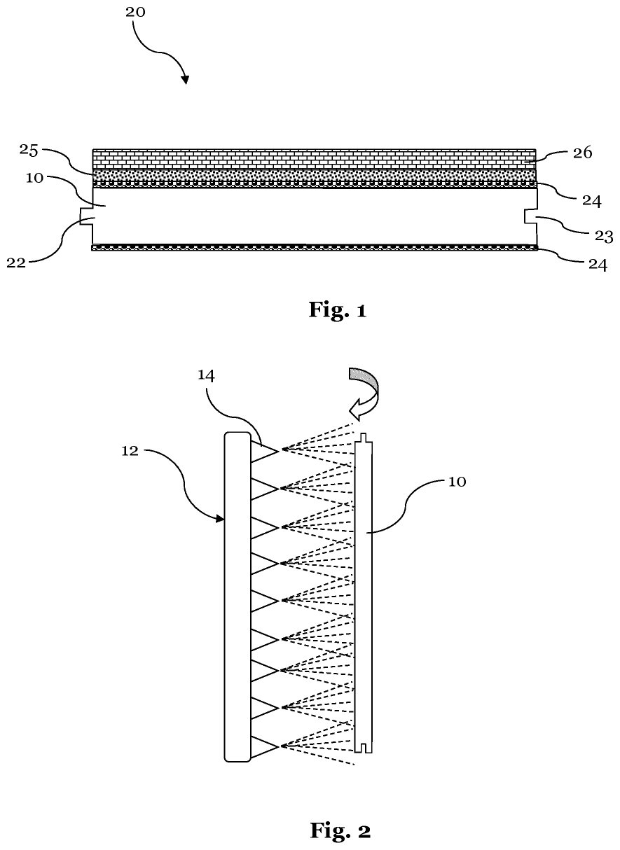

FIG. 1 shows an exemplary layer stack of a panel in accordance with the invention;

FIG. 2 schematically a device for the treatment of a carrier board with water glass; and

FIG. 3 a further schematic illustration of a layer stack.

In FIG. 1, a schematic layer stack for a panel 20 according to the invention is shown. The illustration is schematic and not up to scale. In particular, the carrier board 10 is substantially thicker than the additional layers 24, 25 and 26. Further, the panel 20 can comprise additional layers, in particular grounding layers, primer layers and similar.

In the shown example, carrier board 10 has a thickness of approximately 8 mm and comprises on its surrounding edges coupling means in the form of groove 23 respectively tongue elements 22, which are, however, only shown schematically in the figures. Suitable coupling means in the form of groove and tongue elements, which allow connection of several similar panels by means of form locking, are known to the skilled person from the field of laminate floorings. For the details of such coupling means, it is for example referred to WO 0188306 or WO 0148332 of the same applicant, the contents of which are herewith incorporated by reference. It is generally preferred that the carrier boards according to the appended claims are provided with coupling means in the form of groove and tongue elements that allow connection of several similar panels by means of form-fitting connection. Preferably, the coupling means are machined into the board before the same is e.g. treated with water glass.

At least the front and rear surfaces of carrier board 10 are preferably treated with water glass, so that the surfaces of carrier board 10 are provided with a silica layer 24. In FIG. 1, this layer 24 is only schematically shown at the front and rear surface, however, it is clear to the skilled person that preferably, all surfaces of the carrier board 10 are correspondingly treated with water glass. Onto the front surface of carrier board 10, a layer of a stone veneer 26 is applied. The layer of stone veneer 26 is glued onto the carrier board 10 by means of a layer of an adhesive 25.

In FIG. 2, the treatment of a carrier board 10 by means of an aqueous solution of water glass is schematically shown. The carrier board 10 is already provided with coupling means. A spraying device 12 with a number of spray nozzles 14 sprays a hot, aqueous solution of water glass onto the surface of carrier board 10. The carrier board 10 is rotated in the mist provided by the spray nozzles 14, as it is indicated by the arrow.

Thereby, it is secured that the surface of the carrier board 10 is completely and without any gaps treated with the aqueous solution of water glass.

FIG. 3 shows schematically a layer stack and shall illustrate the roughness respectively irregularity of the layer of stone veneer 26′. The layer of stone veneer 26′ is fixed by means of an adhesive layer 25′ onto the carrier board 10. The adhesive layer 25′ was applied with a thickness of for example 500 μm and subsequently the layer of stone veneer 26′ was pressed onto the surface of the adhesive layer 25′. Thereby, in the final product, as one can see from FIG. 3, different thickness of the layer of adhesive occur.

The present description shall only serve to explain the present invention and is not intended to be limiting. The scope of protection is rather defined by the enclosed claims.

1. A panel, in particular wall, ceiling or flooring panel, comprising a carrier board with a front surface and a rear surface, wherein the carrier board has a thickness of 3 to 30 mm, wherein the carrier board is a board of mineral wool and comprises on its front surface a first layer of an adhesive, as well as a second layer of a stone veneer, which has a thickness of 0.1 to 4 mm, and which is adhered to the carrier board by means of the adhesive.

2. The panel according to claim 1, wherein between the layer of adhesive and the layer of stone veneer additional layers are provided.

3. The panel according to claim 1, wherein the adhesive is a polyurethane adhesive.

4. The panel according to claim 1, wherein the layer of adhesive is present in a thickness of 50 μm to 3 mm, more preferred of 200 μm to 2.5 mm, yet more preferred from 300 μm to 2 mm and most preferred from 500 μm to 2 mm.

5. The panel according to claim 1, wherein the layer of adhesive was applied in a thickness of 50 μm to 3 mm, more preferred from 200 μm to 2.5 mm, even more preferred from 200 μm to 2 mm and most preferred from 500 μm to 2 mm.

6. The panel according to claim 1, wherein the adhesive is present in an amount of 50 to 5,000 g/m², more preferred in an amount of 70 to 4,000 g/m², even more preferred of 300 to 3,000 g/m² and most preferred of 500 to 2,500 g/m².

7. The panel according to claim 1, wherein the elongation at break (according to EN ISO 527-1) of the layer of adhesive is at 100 to 600%, more preferably at 150 to 500% and most preferred at 200 to 400%.

8. The panel according to claim 1, wherein the layer of adhesive has a shore A hardness value (DIN EN ISO 868) of 25 to 95, more preferably of 27 to 80 and most preferably of 30 to 70.

9. The panel according to claim 1, wherein the layer of adhesive has a density between 1,000 and 1,700 kg/m³, more preferred between 1,200 and 1,500 kg/m³.

10. The panel according to claim 1, wherein the carrier board has a thickness between 3 and 20 mm, preferably between 4 and 15 mm, more preferred between 3 and 12 mm and most preferred between 4 and 10 mm.

11. The panel according to claim 1, wherein the carrier board made of mineral wool has a density of 20 to 180 kg/m³, preferably of 30 to 160 kg/m³, more preferably of 40 to 150 kg/m³ and most preferred of 60 to 130 kg/m³.

12. The panel according to any of the preceding claims, wherein the carrier board made of mineral wool has a modified surface, which is achievable by treating the carrier board with a solution of water and water glass, in particular sodium silicate.

13. The panel according to claim 12, wherein the carrier board made of mineral wool comprises a modified surface, which is achievable by spraying the carrier board with the aqueous solution or by dipping the carrier board into the aqueous solution.

14. A method for the manufacturing of a panel, in particular a wall, ceiling or flooring panel, comprising the following steps:
a. providing a carrier board made of mineral wool, with a front surface and a rear surface;
b. treating the carrier board with water glass;
c. gluing a layer of a stone veneer onto the front surface, which has a thickness of 0.1 to 4 mm, by means of a layer of an adhesive.

15. The method according to claim 14, wherein the treatment of the carrier board with water glass is done by means of an aqueous solution of water glass.

16. The method according to claim 15, wherein the aqueous solution is mixed before the treatment of the carrier board as follows (proportion of weight):
1 part water glass and 1 to 10 parts of water, preferably 1 part water glass and 1.5 to 7 parts of water and most preferably 1 part water glass and 1.5 to 3 parts of water.

17. The method according to claim 15, wherein the carrier board is sprayed with the aqueous solution or is dipped into the aqueous solution.

18. The method according to claim 14, wherein the carrier board is dried after the treatment and before the layer of stone veneer is glued onto the board.

19. The method according to claim 14, wherein the method after step b. comprises the following step: applying a layer of adhesive in a thickness of 50 μm to 3 mm, more preferred from 200 μm to 2.5 mm, even more preferred from 300 μm to 2 mm and most preferred from 500 μm to 2 mm.
